(19) United States
(12) Patent Application Publication
(10) Pub. No.: US 2024/0227579 A1
(43) Pub. Date: Jul. 11, 2024

(54) METHODS AND SYSTEMS FOR POWER AUTHORITY CONTROL IN A BEV

(71) Applicant: Ford Global Technologies, LLC, Dearborn, MI (US)

(72) Inventors: Yanan Zhao, Ann Arbor, MI (US); Carol Okubo, Dearborn, MI (US); Ming L. Kuang, Canton, MI (US)

(21) Appl. No.: 18/153,194

(22) Filed: Jan. 11, 2023

(51) Int. Cl. B60L 15/20

(52) U.S. Cl. CPC B60L 15/2045; B60L 2240/421; B60L 2240/423

(57) ABSTRACT

Methods and systems are provided, including a method for an electric vehicle having at least two motors providing drive torque. In one example, the method comprises operating with speed damping control, including determining that a first motor has more power authority than requested and a second motor has a shortage of power authority, and in response, reallocating power authority from the first motor to the second motor to increase usage of authorized power for speed damping. In one example of the method, the first motor and the second motor are in electronic communication with a centralized integrated control system.

### FIELD

The present description relates generally to methods and systems for controlling battery power allocation in a vehicle.

### BACKGROUND/SUMMARY

Electric vehicles are selectively driven using one or more battery-powered electric machines. The electric machines, also referred to as motors or electric motors, provide motive power to the vehicle instead of, or in addition to, an internal combustion engine. Example electric vehicles include battery electric vehicles (BEVs) with an energy storage device such as a battery containing multiple battery cells that store electrical power for powering the electric machine. Battery capacity may vary over the lifetime of the device and maintaining operation within battery power thresholds on both charging and discharging during vehicle operation is generally desirable. Furthermore, vehicle performance may be enhanced by fully utilizing battery capability when desired.

Battery power control ensures instantaneous electrical power usage from the total of all motors and high voltage (HV) accessories do not exceed battery power thresholds. Power allocation control distributes available electrical power thresholds to each motor. Allocated power thresholds include an upper threshold that is a maximum threshold of electrical power granted to the motor for motoring (or driving) and a lower threshold that is a minimum threshold of electrical power granted to the motor for generating (or braking). The allocated power thresholds may be referred to as a power authority or authorized power for the motor or motors.

A BEV may be equipped with multiple independent electric motors. As one example, a BEV having a motor positioned at each wheel may be referred to as a 4-motor BEV. A 3-motor BEV is a configuration with a motor at each corner of one axle and a single motor at the other axle. A 2-motor BEV is a configuration with a first motor at the front axle and second motor at the rear axle. 3-motor and 4-motor BEV configurations enable independent wheel torque control, and all three configurations provide control flexibility for torque vectoring, vehicle lateral control, and off-road feature controls etc. Each motor may operate at different torque requests and different speeds, thus consuming or generating electric power. To ensure compliance with the power thresholds, the torque request of each motor is converted to a corresponding power request and compared with the allocated power thresholds. Power allocation control is activated to clip the desired motor torque request if the request is greater than the allocated power thresholds.

Active motor damping (AMD), also referred to as speed damping, is a control for damping motor speed oscillations during motor torque control mode to reduce potential driveline oscillation. For example, AMD may include estimating a difference between an actual motor speed and a filtered (or ideal) motor speed and providing a feedback correction of the motor torque request based on the difference. Often, the correction is applied after power allocation control of the motor torque request to ensure AMD delivery without interference from power control clipping.

However, the inventors herein have recognized an issue with the above AMD control. For independently controlled motors, such as 2-motor, 3-motor, and 4-motor BEVs having AMD control residing in separate control modules, in some examples, a first motor of the system may request less power for AMD control than the power authority granted to the first motor, thus having a surplus of power. At the same time a second motor of the system may have lack sufficient power authority to provide a request for AMD control without degraded performance. A centralized AMD power authority control system may resolve some of the aforementioned challenges.

In one example, the issues described above may be addressed by a method for an electric vehicle having at least two motors providing drive torque, the method comprising: operating with speed damping control, including determining that a first motor has more power authority than requested and a second motor has a shortage of power authority, and in response, reallocating power authority from the first motor to the second motor to increase usage of authorized power for speed damping. In this way, power authority for speed damping may be allocated in compliance with electrical power thresholds.

In one example of the method, the first motor and the second motor are in electronic communication with a centralized integrated control system. In one example, the method further comprises receiving a first raw upper threshold and a first raw lower threshold of authorized power for speed damping and a first raw power request from the first motor and a second raw upper threshold and a second raw lower threshold of authorized power for speed damping and a second raw power request from the second motor. In one example, the method includes adjusting power thresholds of the first motor and the second motor based on a comparison between a total raw upper threshold calculated from the first raw upper threshold and the second raw upper threshold, a total raw lower threshold calculated from the first raw lower threshold and the second raw lower threshold, and a total raw power request calculated from the first raw power request and the second raw power request. In one example, in response to the total raw power request being more than the total raw upper threshold or the total raw power request being less than the total raw lower threshold, and the first motor having more power authority than requested, the method includes setting an adjusted upper threshold and an adjusted lower threshold of authorized power to the power request of the first motor and setting the adjusted upper threshold and the adjusted lower threshold of authorized power for the second motor based on an available power authority for speed damping. In one example, the method includes constraining a torque request for speed damping based on the adjusted power thresholds and providing the torque request to actuators of the at least two motors to dampen driveline oscillation.

The disclosed methods consider the power request for speed damping and power authority from two or more motors of the system together and dynamically adjust power thresholds therebetween based on the requests in total. By adjusting power authority in this way, an electric vehicle with at least two motors may comply with electrical power thresholds. The technical effect of adjusting authorized power for speed damping dynamically is that operation of 2-motor, 3-motor, and 4-motor configuration BEVs may be enabled providing drivers more choice in the electric vehicle market.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of a vehicle driveline.

FIG. 2A is a plot illustrating a first scenario of AMD power authority control.

FIG. 2B is a plot illustrating a second scenario of AMD power authority control.

FIG. 3 is a flow chart illustrating a high-level view of a method for centralized AMD power authority control using 4-motor BEV as an example.

FIG. 4A is a flow chart illustrating a first method for centralized AMD power authority control.

FIG. 4B is a flow chart illustrating a second, third, and fourth control method for centralized AMD power authority control.

FIG. 4C is a flow chart detailing the fourth method for centralized AMD power authority control.

FIG. 5 is a timing diagram illustrating an example prophetic operation of a centralized AMD power authority control method.

### DETAILED DESCRIPTION

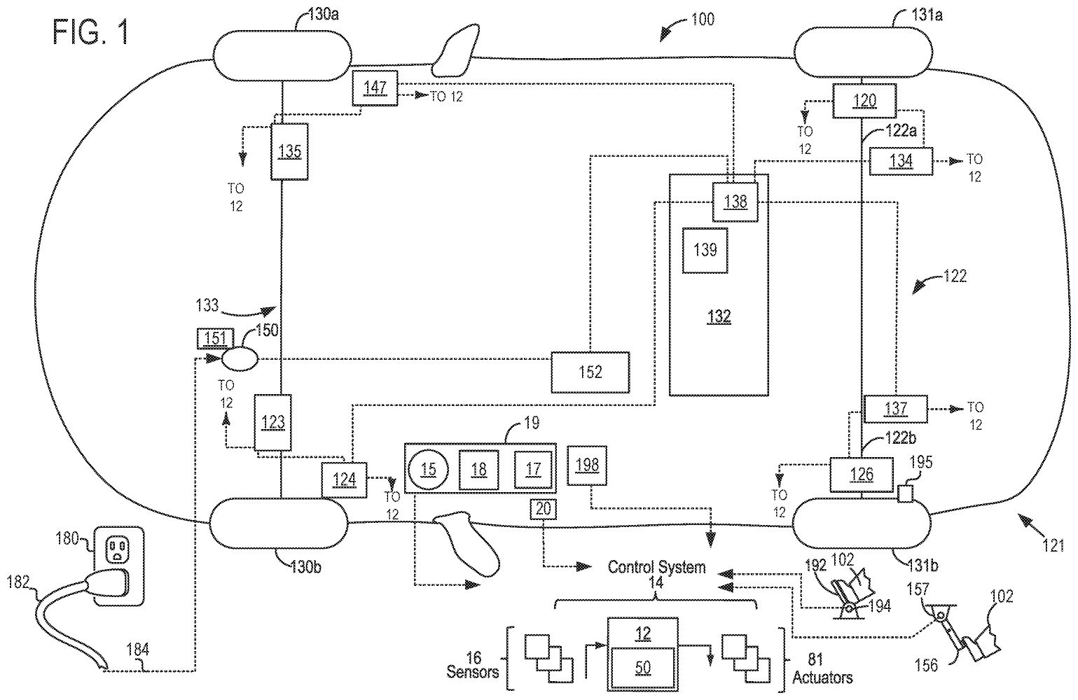

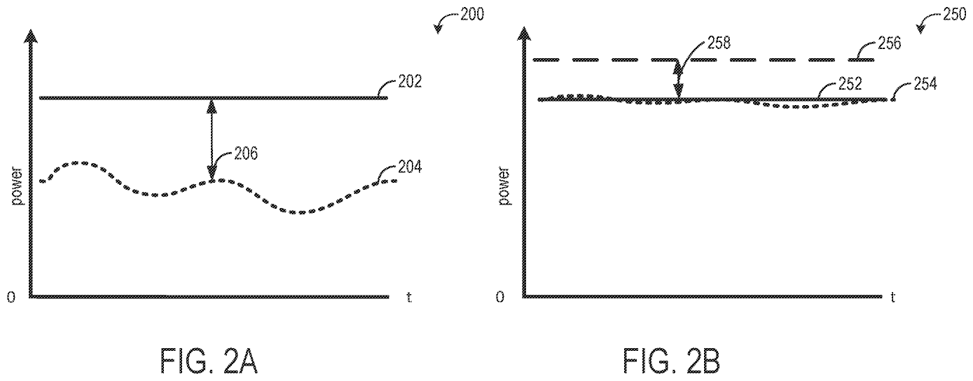

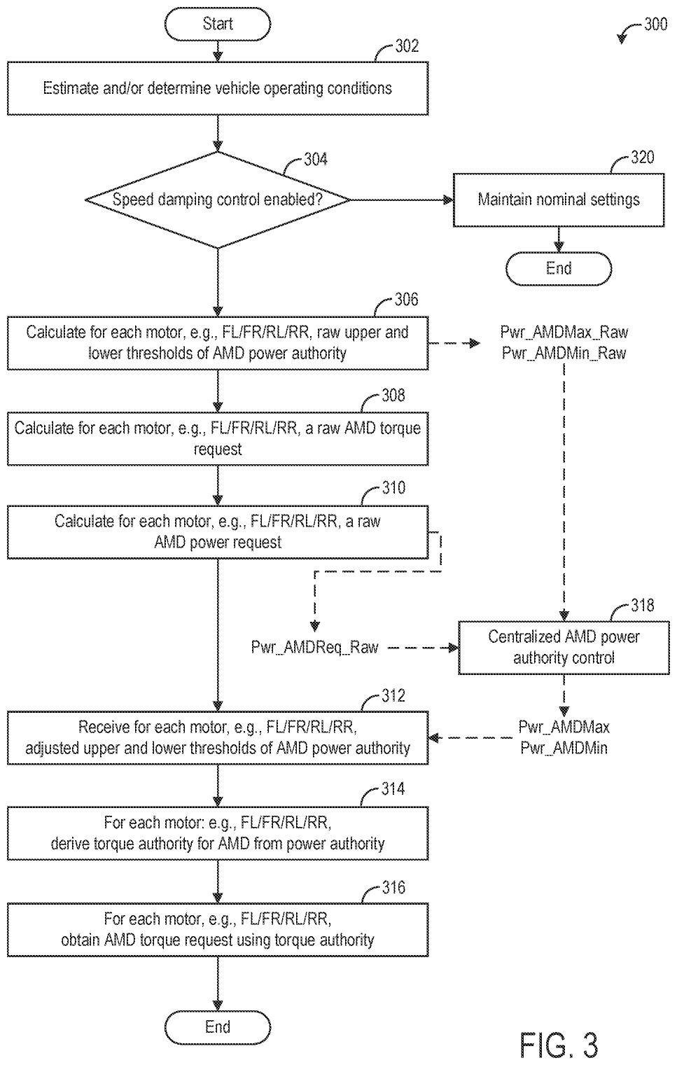

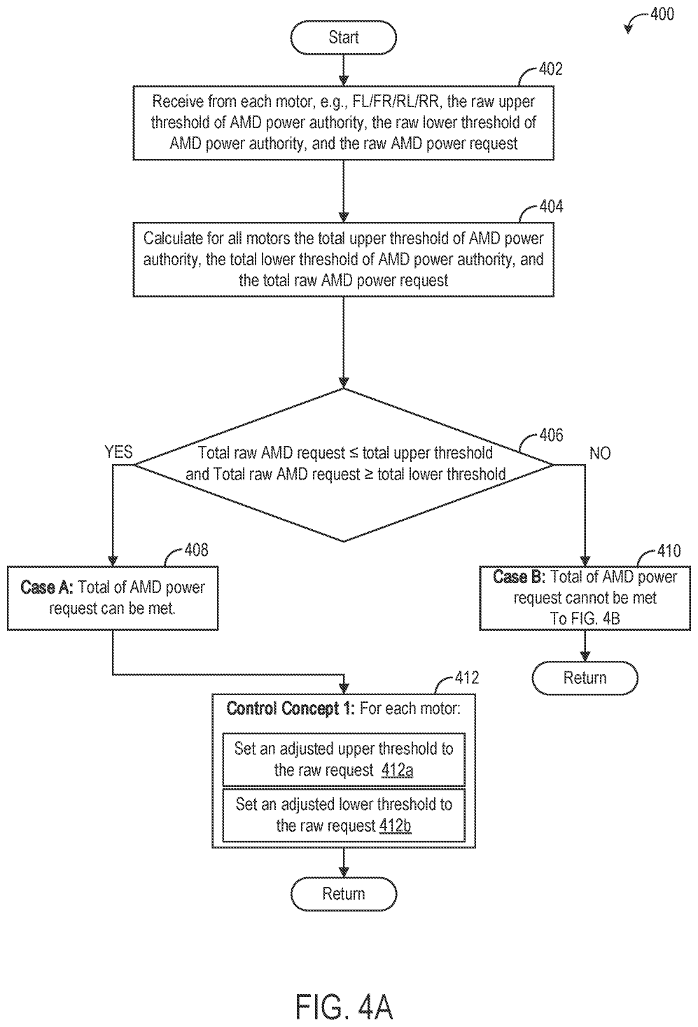

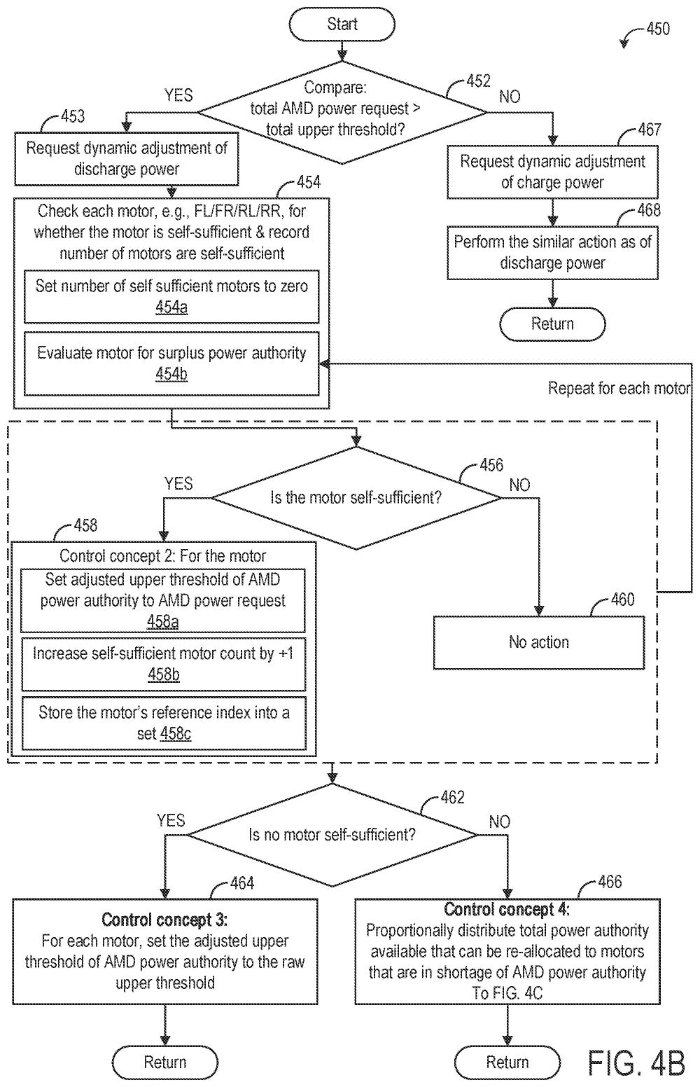

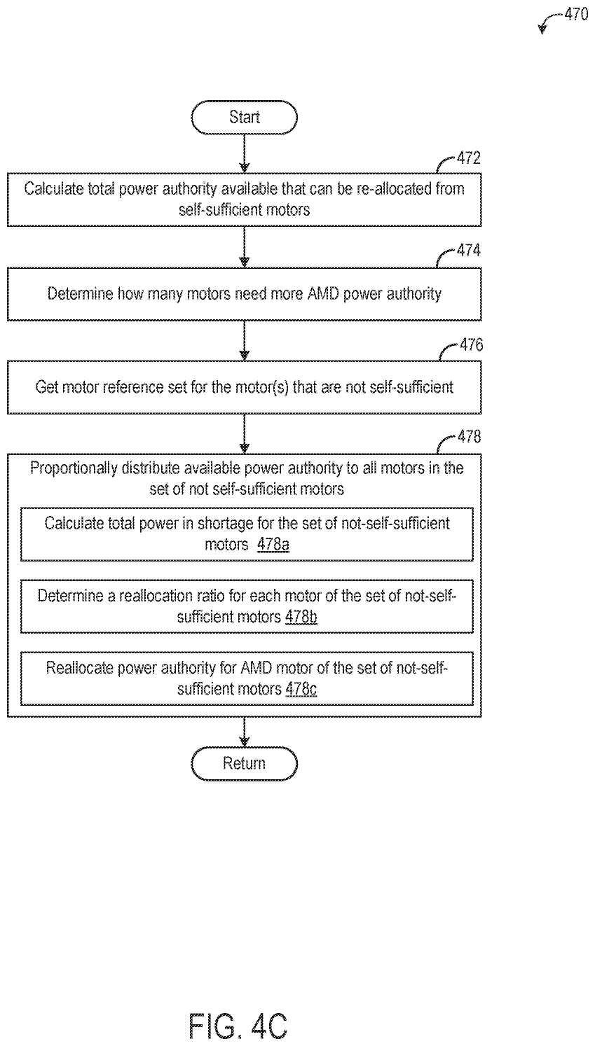

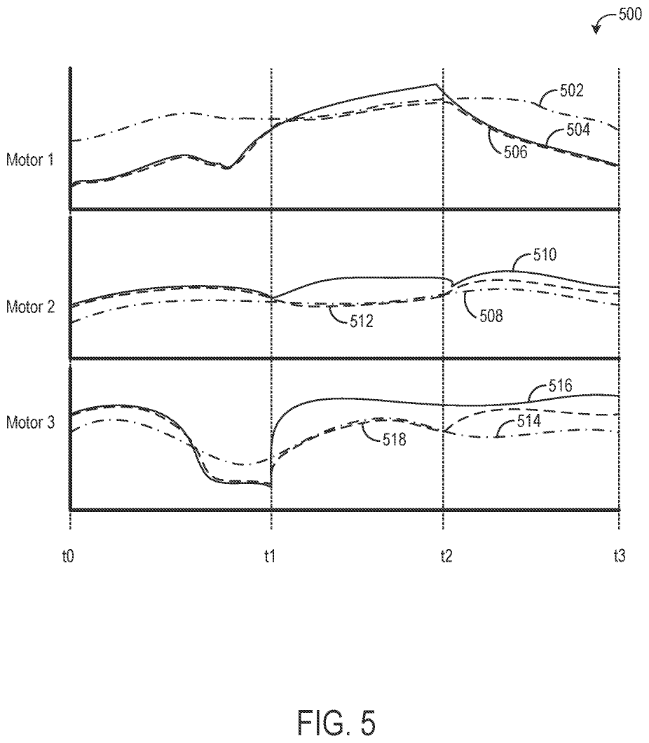

The following description relates to systems and methods for controlling active motor damping (AMD) power authority in a battery electric vehicle with at least two motors using a centralized integrated control system. To manage AMD power requests, a control system may grant maximum and minimum power thresholds for AMD above and beyond power allocation thresholds for a torque request. The maximum and minimum power thresholds granted for AMD control may be referred to as AMD power authority or power authorized for speed damping. FIG. 1 shows an example vehicle system that includes a driveline with four electric motors in electronic communication with a centralized integrated control system. During motor torque control mode, the vehicle system may use AMD to control motor speed oscillations for one or more of the electric motors of the system. In some examples, a motor may generate a power request for AMD exceeding electrical power allocations for the motor. FIG. 2A and FIG. 2B are plots showing exemplary power authority allocation scenarios during active motor damping. Centralized control of power authority for all electric motors of the system may increase performance of speed damping by considering the AMD power request and AMD power authority allocated to each motor together and dynamically adjusting AMD power authority based on demand and an available total AMD power authority. A controller in electronic communication with a centralized AMD power authority control system may be configured to perform control methods, such as the example method of FIG. 3, to receive AMD power authority thresholds and AMD power requests from each motor of the system, and adjust AMD power authority allocated to each motor in response. AMD torque authority for each motor may be derived based on the AMD power authority and motor speed. A final torque request for speed damping may be constrained by the AMD torque authority and the torque request transmitted to an actuator of the motor for feedback control of motor oscillations. FIG. 4A, FIG. 4B, and FIG. 4C are a series of flow charts illustrating in more detail example methods for centralized AMD power authority control for a BEV having two or more electric motors. A prophetic example of a centralized AMD power authority control method is shown in FIG. 5.

FIG. 1 illustrates an example vehicle propulsion system 100 for vehicle 121. Throughout the description of FIG. 1, mechanical connections between various components are illustrated as solid lines, whereas electrical connections between various components are illustrated as dashed lines. Vehicle propulsion system 100 is shown with a first electric machine (e.g., a propulsive force electric machine, motor/generator) 120, a second electric machine 135, a third electric machine 123, and a fourth electric machine 126 for propelling vehicle 121. Electric machines 120, 135, 123, 126 are controlled via controller 12. In one example, electric machines 120, 135, 123, 126 are independent. For example, electric machines 120, 135, 123, 126 may have independently controlled torque and/or power and/or speed. Controller 12 receives signals from the various sensors shown in FIG. 1. In addition, controller 12 employs the actuators shown in FIG. 1 to adjust driveline operation based on the received signals and instructions stored in memory of controller 12. In some examples, the vehicle propulsion system 100 may include an internal combustion engine (not shown).

Vehicle propulsion system 100 has a front axle 133 and a rear axle 122. In some examples, rear axle 122 may comprise two half shafts, for example first half shaft 122a, and second half shaft 122b. Vehicle propulsion system 100 further includes front wheels 130a, 130b and rear wheels 131a, 131b. In this example, front wheels 130a, 130b, and/or rear wheels 131a, 131b may be driven via electrical propulsion sources. Electric machine 120 is shown incorporated into a corner of rear axle 122 near rear wheel 131a and electric machine 126 is shown incorporated into the other corner of rear axle 122 near rear wheel 131b. Electric machine 135 is shown incorporated into a corner of front axle 133 near front wheel 130a and electric machine 123 is shown incorporated into the other corner of front axle 133 near front wheel 130b. The electric machines may also be referred to herein as motors or electric motors. Vehicle propulsion system 100 is shown as a 4-motor BEV; however, in some examples, a single electric machine may be coupled to the front axle 133 and a pair of electric machines may be coupled to the rear axle 122 in a 3-motor configuration. In yet other examples, a pair of electric machines may be coupled to the front axle 133 and a single electric machine may be coupled to the rear axle 122 for an additional or alternative 3-motor configuration. As a further example, a single electric machine may be coupled to the front axle 133 and a single electric machine may be coupled to the rear axle 122 in a 2-motor configuration.

Electric machines 120, 135, 123, and 126 may receive electrical power from electric energy storage device 132 (also referred herein as an electric vehicle battery or high voltage (HV) battery). Electric energy storage device 132 is an onboard electrical energy storage device. Furthermore, first and second electric machines 120 and 135 may provide a generator function to convert the kinetic energy of the vehicle into electrical energy, where the electrical energy may be stored at electric energy storage device 132 for later use by electric machines 120, 135, 126, and/or 123. A first inverter system controller 134 may convert alternating current (AC) generated by electric machine 120 to direct current (DC) for storage at electric energy storage device 132 and vice versa. A second inverter system controller 147 may convert AC generated by electric machine 135 to DC for storage at electric energy storage device 132 and vice versa. A third inverter system controller 124 may convert AC generated by electric machine 123 to DC for storage at electric energy storage device 132 and vice versa. A fourth inverter system controller 137 may convert AC generated by electric machine 126 to DC for storage at electric energy storage device 132 and vice versa. Electric energy storage device 132 may be a battery, capacitor, inductor, or other electric energy storage device.

In some examples, electric energy storage device 132 may be configured to store electrical energy that may be supplied to other electrical loads residing on-board the vehicle (other than the motors), including HV components such as cabin heating and air conditioning, headlights, cabin audio and video systems, etc.

Control system 14 may communicate with one or more of electric machine 120, electric energy storage device 132, electric machine 135, electric machine 123, electric machine 126, and so on. Control system 14 may receive sensory feedback information from one or more of electric machine 135, electric machine 120, electric machine 123, electric machine 126, electric energy storage device 132, etc. Further, control system 14 may send control signals to one or more of electric machine 135, electric machine 120, electric machine 123, electric machine 126, electric energy storage device 132, etc., responsive to this sensory feedback. Control system 14 may receive an indication of an operator requested output of the vehicle propulsion system from a human operator 102, or an autonomous controller. For example, control system 14 may receive sensory feedback from pedal position sensor 194 that communicates with pedal 192. Pedal 192 may refer schematically to an accelerator pedal. Similarly, control system 14 may receive an indication of an operator requested vehicle braking via a human operator 102, or an autonomous controller. For example, control system 14 may receive sensory feedback from a pedal position sensor 157 that communicates with brake pedal 156. Control system 14 is shown receiving information from a plurality of sensors 16 (various examples of which are described herein) and sending control signals to a plurality of actuators 81 (various examples of which are described herein). As one example, sensors 16 may include one or more wheel speed sensors 195, and ambient temperature/humidity sensor 198. Vehicle propulsion system 100 may further include an accelerometer 20.

Electric energy storage device 132 may periodically receive electrical energy from a power source 180 (e.g., a stationary power grid) residing external to the vehicle (e.g., not part of the vehicle) as indicated by arrow 184. As a non-thresholding example, vehicle propulsion system 100 may be configured as a plug-in electric vehicle, whereby electrical energy may be supplied to electric energy storage device 132 from power source 180 via an electrical energy transmission cable 182. During a recharging operation of electric energy storage device 132 from power source 180, electrical energy transmission cable 182 may electrically couple electric energy storage device 132 and power source 180. In some examples, power source 180 may be connected at inlet port 150. Furthermore, in some examples, a charge status indicator 151 may display a charge status of electric energy storage device 132.

Electric energy storage device 132 includes an electric energy storage device controller 139 and a power distribution module 138. Electric energy storage device controller 139 may provide charge balancing between energy storage element (e.g., battery cells) and communication with other vehicle controllers (e.g., controller 12). Power distribution module 138 controls flow of power into and out of electric energy storage device 132.

In some examples, electrical energy from power source 180 may be received by charger 152. For example, charger 152 may convert alternating current from power source 180 to direct current (DC), for storage at electric energy storage device 132.

While the vehicle propulsion system is operated to propel the vehicle, electrical energy transmission cable 182 may be disconnected between power source 180 and electric energy storage device 132. Control system 14 may identify and/or control the amount of electrical energy stored at the electric energy storage device, which may be referred to as the state of charge (SOC).

In other examples, electrical energy transmission cable 182 may be omitted, where electrical energy may be received wirelessly at electric energy storage device 132 from power source 180. For example, electric energy storage device 132 may receive electrical energy from power source 180 via one or more of electromagnetic induction, radio waves, and electromagnetic resonance. As such, it should be appreciated that any suitable approach may be used for recharging electric energy storage device 132 from a power source that does not comprise part of the vehicle. In this way, electric machine 120, electric machine 135, electric machine 123, and electric machine 126 may propel the vehicle by utilizing a stationary electric power source.

Electric energy storage device 132 may have a discharge and/or charge power threshold beyond which supply of energy to and/or from the electric energy storage device 132, for some length of time, may degrade the device 132. The vehicle propulsion system 100 may include control methods for ensuring instantaneous battery power usage from electric machine 120, electric machine 135, electric machine 123, and electric machine 126, and HV accessories does not exceed battery power thresholds.

Controller 12 may comprise a portion of a control system 14. Controller 12 as shown in FIG. 1 may be a microcomputer, including a microprocessor unit, input/output ports, an electronic storage medium, random access memory, keep alive memory, and a data bus. The electronic storage medium may include a non-transitory read-only memory chip for executable programs (e.g., executable instructions) and calibration values. As one example, the controller 12 may include instructions for controlling battery power threshold charge and discharge including a motoring power threshold (or positive electrical power threshold) and a generating power threshold (or negative electrical power threshold). For example, controller 12 may calculate the motoring power threshold by subtracting a total high voltage accessory power consumption from the battery discharge power threshold. The controller 12 may calculate the generating power threshold by subtracting the total high voltage accessory power consumption from the battery charge power threshold. In one example, the controller 12 may include instruction for allocating the motoring power threshold and generating power threshold among the plurality of electric machines using a split ratio based on the torque requests. In another example, the motoring power threshold and generating power threshold may be allocated to electric machine 120, electric machine 135, electric machine 123, and electric machine 126 based on a power allocation ratio relative to the total electrical power thresholds (e.g., motoring or generating) using inputs such as motor torque request, motor speed, and the actual electrical power consumed by the motors. The motors may then be operated with an allocated maximum power threshold and an allocated minimum power threshold based on the power allocation ratio. As another example, a strategy for power allocation control may include converting the torque request of each motor to a corresponding power request, comparing the power request with the allocated maximum power threshold and the allocated minimum power threshold authorized for the motor, and activating power control to clip (e.g., reduce) the request if the request exceeds the threshold.

The controller 12 may include instructions for AMD control. For example, the plurality of motors may be controlled for damping motor speed oscillations during torque control mode to prevent potential driveline oscillation. AMD control may include estimating a difference between an actual motor speed and a filtered (or ideal) motor speed and providing a feedback correction of the motor torque request based on the difference. The correction may be applied after power allocation control of the motor torque request to ensure AMD delivery without interference from power control clipping; however AMD control may be constrained by AMD power thresholds.

In one example, power authority granted for AMD control may be controlled by a centralized AMD power authority control system 50. The centralized AMD power authority control system 50 may comprise a portion of controller 12. In one example, the centralized AMD power authority control system 50 may be an integrated vehicle control module including powertrain controls for electric machine 120, electric machine 135, electric machine 123, and electric machine 126. In one example, centralized AMD power authority control system 50 receives an initial or raw request for power to dampen speed oscillations, a raw upper threshold of AMD power authority, and a raw lower threshold of AMD power authority from each motor and reallocates AMD power authority among the motors under various use cases. As one example, during vehicle operation with speed damping control, the centralized AMD power authority control system 50 may reallocate power authority from a first motor (e.g., electric machine 120) to a second motor (e.g., electric machine 135) in response to determining that the first motor has more power authority than requested and the second motor has a shortage of power authority. The reallocated power authority may be transmitted to the controller 12 as adjusted AMD power authority thresholds and the final torque request for AMD is adjusted based on the thresholds. For example, the controller 12 may derive a maximum threshold of torque authority as a function of an adjusted maximum threshold of power authority and a motor speed. The controller 12 may obtain a minimum threshold of torque authority similarly. The controller 12 may obtain a final AMD torque request constrained by the maximum threshold of torque authority and the minimum threshold of torque (e.g., a torque range authority).

Vehicle propulsion system 100 may also include an on-board navigation system 17 (for example, a Global Positioning System) on dashboard 19. In one example, an operator of the vehicle may interact with the on-board navigation system 17. The navigation system 17 may include one or more location sensors for assisting in estimating a location (e.g., geographical coordinates) of the vehicle. For example, on-board navigation system 17 may receive signals from GPS satellites (not shown), and from the signal identify the geographical location of the vehicle. In some examples, the geographical location coordinates may be communicated to controller 12.

Dashboard 19 may further include a display system 18 configured to display information to the vehicle operator. Display system 18 may comprise, as a non-thresholding example, a touchscreen, or human machine interface (HMI), display that enables the vehicle operator to view graphical information as well as input commands. In some examples, display system 18 may be connected wirelessly to the internet (not shown) via controller (e.g. controller 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 135 and electric machine 120) based on an operator input. Various examples of the operator interface 15 may include interfaces that require a physical apparatus, such as an active key, that may be inserted into the operator interface 15 to turn on the vehicle, or may be removed to turn off the vehicle. Other examples may include a passive key that is communicatively coupled to the operator interface 15. The passive key may be configured as an electronic key fob or a smart key that does not have to be inserted or removed from the operator interface 15 to operate the vehicle. Rather, the passive key may need to be located inside or proximate to the vehicle (e.g., within a threshold distance of the vehicle). Still other examples may additionally or optionally use a start/stop button that is manually pressed by the operator to turn the vehicle on or off. In other examples, a remote vehicle start may be initiated remote computing device (not shown), for example, a cellular telephone, or smartphone-based system where a user's cellular telephone sends data to a server and the server communicates with controller 12 to start the vehicle.

In this way, the systems of FIG. 1 enable a system for an electrically propelled vehicle, comprising: an electric vehicle battery, a first motor coupled to a first axle of the vehicle, a second motor coupled to the first axle of the vehicle, a third motor coupled to a second axle of the vehicle, and a fourth motor coupled to the second axle of the vehicle, and a centralized integrated control system in communication with the electric vehicle battery, the first motor, the second motor, the third motor, and the fourth motor. The system further includes a controller including executable instructions stored in non-transitory memory that cause the centralized integrated control system to set an upper threshold and lower threshold for AMD power authority based on a raw AMD power request of each motor in response to a total AMD power authority exceeding a total raw AMD power request from all motors. In response to a request for a dynamic adjustment of AMD power authority for a motor, the centralized integrated control system may set an adjusted upper threshold and adjusted lower threshold for AMD power authority to the raw AMD power request of the motor if AMD power authority exceeds the raw AMD power request of the motor and reallocate available total AMD power authority to one or more motors that are in shortage of AMD power authority. In one example, the centralized integrated control system may reallocate total AMD power authority to one or more motors in shortage of AMD power authority proportionally based on a power ratio, where the power ratio is calculated as an absolute value of a power authority shortage of a first motor of the one or more motors that are in shortage as a proportion of a total power authority shortage calculated from the one or more motors that are in shortage. In one example, the available total AMD power authority may be proportionally distributed between no more than three motors. In one example, the executable instructions may cause the centralized integrated control system to set an adjusted threshold for AMD power authority to a raw threshold allocated to each motor in response to the total raw AMD power request exceeding a total raw AMD power authority from all motors. In one example, the executable instructions may cause the controller to command an AMD torque request for each motor constrained by an adjusted upper threshold and adjusted lower threshold for AMD power authority and motor speed. In this way, the AMD power authority may be allocated to achieve speed damping in compliance with electrical power thresholds.

FIG. 2A and FIG. 2B are plots illustrating AMD power authority control of a motor in a first scenario 200 and the motor in second scenario 250. The example illustrates control of a maximum AMD power authority. In other words, control of an upper threshold of electrical power that may be used to dampen speed oscillations for a motor after power allocation for a torque request. The x-axis represents time and the y-axis represents electrical power. In the example, AMD power authority may be based on an allocated maximum electrical power threshold, a power request before AMD, the difference between the threshold and the power request before AMD, and a calibratable power authority that may be granted under some scenarios. In one example, the allocated maximum electrical power threshold may be based on one or more of vehicle operating conditions, a discharge threshold of an electrical energy storage device, and the power requests of the motors before AMD, such as described with respect to FIG. 1. In one example, the power request before AMD may be the power requested by the motor to meet a torque request. The difference between the threshold and the request may be an amount of authorized power that is available for AMD without granting additional power authority.

The first scenario 200 includes a first allocated maximum electrical power threshold or a first threshold 202, a first electrical power request or a first request 204 of the motor before AMD, and a first available power 206 that is the difference between the first threshold 202 and the first request 204. The second scenario 250 includes a second allocated maximum electrical power threshold or a second threshold 252, a second electrical power request or a second request 254 before AMD, a maximum potential power usage after AMD 256, and a calibratable power authority 258 that is the difference between the second threshold 252 and the maximum potential power usage after AMD 256.

In the first scenario 200, the power request of the motor before AMD, e.g., first request 204, is lower than the allocated maximum electrical power threshold, e.g., first threshold 202. The difference between the two, e.g., the first available power 206, represents surplus power authority that may be used by the motor for AMD control. In the second scenario 250, the power request of the motor before AMD, e.g., second request 254, may be the same or more than the allocated maximum electrical power threshold to the motor, e.g., the second threshold 252. For example, the power request to fulfil a torque request is already clipped by the allocated power threshold. In this second scenario, the calibratable power authority 258 may be granted to AMD control. The calibratable power authority may be granted for AMD to prevent driveline oscillation. In one example, a calibration may depend on drivability demands specific to the vehicle. In another example, battery power usage of the vehicle may be considered in the calibration. In one example, the calibration may consider the number of independent motors of the vehicles. For example, the calibration may be smaller for a 4-motor BEV than for a 2-motor BEV.

Overall, considering both scenarios may happen at different time instants during operation of the motor, a maximum power authority granted to AMD control at each time instant may be determined as the maximum of the calibratable power authority and the available power:

Pwr_{amdMax}=Max(Pwr_{Avai},Pwr_{amdAuth}).

A minimum power authority granted to AMD control may be determined similarly:

Pwr_{amdMin}=Min(Pwrₐᵥₐᵢ,(−1)*Pwr_{amdAuth}).

The power authorities for AMD control can be converted to a torque range authority, based on which motor's torque request for AMD is constrained to the torque range authority. In such an example, there may be a tradeoff between delivering speed damping and protecting battery life.

In 2-motor, 3-motor, or 4-motor BEV systems, a first motor may have more power authority than requested for AMD at the same time a second motor has less power authority than requested for AMD. Systems and methods that integrate AMD power authority control of each motor of a 2-motor, 3-motor, or 4-motor BEV system may reduce a frequency of scenarios where the first motor has more power authority than requested and the AMD performance of the second motor is needlessly degraded due to power authority shortage. For example, the centralized AMD power authority control system described herein integrates powertrain control into a single control architecture to consider all motors' AMD power requests together and distribute AMD power authority under various use cases.

Control methods for allocating AMD power authority in a centralized integrated control system are described below with reference to FIG. 3, FIGS. 4A, 4B, and 4C. In the present disclosure, method 300 illustrates high-level view of the centralized AMD power authority control. The method 300 and the other methods illustrated herein may be executed in a 2-motor, 3-motor, or 4-motor BEV system such as the vehicle propulsion system 100 in FIG. 1 including the centralized AMD power authority control system 50 in electronic communication with electric machines 135, 123, 120, and 126, electric energy storage device 132, and the controller 12. The control methods are described in more detail with reference to FIGS. 4A-4C. Further, at least portions of the method of FIG. 3 and the other methods described herein may be incorporated as executable instructions stored in non-transitory memory while other portions of the method may be performed via a controller transforming operating states of devices and actuators in the physical world. As one example, the method 300 describes controls for a 4-motor BEV system. The motors are represented as FL (front left), FR (front right), RL (rear left), and RR (rear right). In the flow chart, dash lines indicate transfer of information from prior calculations to future calculations.

At 302, the method 300 includes estimating and/or determining vehicle operating conditions. For example, vehicle operating conditions may include charge and discharge thresholds of the electric vehicle battery, battery state of charge, total instantaneous electrical power usage, allocated maximum and minimum power thresholds to meet a torque request (e.g., before AMD) for each motor of the system, driver torque demand, a drive mode such as motor torque control mode or motor speed control mode, vehicle travelling speed, motor speed, and so on.

At 304, the method 300 includes judging whether speed damping control is enabled. In one example, the vehicle system may include a multitude of operating modes. For example, the method 300 may operate the vehicle with speed damping control when the vehicle is operating in a motor torque control mode. For example, when the vehicle is operating in the motor torque control mode, AMD is enabled and AMD torque correction is continuously calculated such that the amount of AMD torque correction changes dynamically. In another example, operating with speed damping control may be a speed damping mode. In another example, in motor speed control mode, where a target reference motor speed is determined and delivered by a torque request tracking the target motor speed, AMD may be disabled. If speed damping control is not enabled the method 300 maintains nominal settings at 320.

At 306, the method 300 includes calculating for the front left motor, the front right motor, the rear left motor, and the rear right motor a raw upper threshold and a raw lower threshold of AMD power authority. The raw upper threshold of AMD power authority may be a raw maximum AMD power authority: Pwr_AMDMax_Raw. The raw lower threshold of AMD power authority may be a raw minimum AMD power authority: Pwr_AMDMin_Raw. The raw upper and lower thresholds of AMD power authority for each motor are transferred to the centralized AMD power authority control at 318. In one example, the raw maximum AMD power authority and raw minimum AMD power authority may be determined similarly as described with respect to FIGS. 2A-2B. For example, the raw maximum AMD power authority may be the larger value of the available allocated power after fulfilling a torque demand and a calibratable AMD power authority.

At 308, method 300 includes calculating for the front left motor, the front right motor, the rear left motor, and the rear right motor a raw AMD torque request. For example, the raw AMD torque request may be an amount of torque determined to apply to the motor based on the difference between the actual and filtered (or ideal) motor speed. In one example, the raw AMD torque request may be calculated as follows:

$${Tq}_{{AMDReq}_{Raw}} = clip ( {Tq}_{minCal} , {Tq}_{FRCorr} , {Tq}_{maxCal} ) ,$$

where Tq_{FBCorr} is the AMD torque request correction term determined by closed-loop feedback control, T_{qminCal} is a calibrated minimum torque allowed for the raw AMD torque request, and Tq_{maxCal} is a calibrated maximum allowed for the raw AMD torque request. In one example, closed-loop feedback control may be controlled by a proportional-integral-derivative (PID) controller.

At 310, the method 300 includes calculating for the front left motor, the front right motor, the rear left motor, and the rear right motor a raw AMD power request. The AMD raw electrical power request may be calculated by multiplying the raw AMD torque request and the motor speed plus an electrical power loss term. In one example, raw AMD power request may be calculated as follows:

$${Pwr}_{{AMDReq}_{Raw}} = {Tq}_{{AMDReq}_{Raw}} * {Spd}_{mtr} + {Pwr}_{loss} ,$$

where Tq_{AMDReq}_{_{Raw}} is the raw amount of torque requested for AMD control, Spdₘₜᵣ is the speed of the motor (e.g., front left, front right, etc.), and Pwrₗₒₛₛ is the electrical power loss term to deliver the corresponding mechanical power request (e.g., Tq_{AMDReq}_{_{Raw}}*Spdₘₜᵣ). The calculated AMD raw power request is transferred to the centralized AMD power authority control at 318.

At 312, the method 300 includes receiving from the centralized AMD power authority control at 318 an adjusted upper threshold and adjusted lower threshold of AMD power authority for the front left motor, the front right motor, the rear left motor, and the rear right motor. The adjusted upper threshold of AMD power authority may be an adjusted maximum AMD power authority: Pwr_AMDMax. The adjusted lower threshold of AMD power authority may be an adjusted minimum AMD power authority: Pwr_AMDMin. In one example, the adjusted upper threshold of AMD power authority and the adjusted lower threshold of AMD power authority may be determined by evaluating the total AMD raw power requests and the total AMD power authority thresholds (upper and lower) for all motors together, and re-distributing power authority among the motors based on available power authority and demand. Example methods for adjusting the upper and lower thresholds of AMD power authority are described in more detail in FIGS. 4A-4C.

At 314, the method 300 includes deriving an upper threshold and a lower threshold of torque authority for AMD based on the adjusted thresholds of AMD power authority for the front left motor, the front right motor, the rear left motor, and the rear right motor. The torque authority AMD maximum may be derived from the upper threshold of AMD power authority and the motor speed. In one example, a torque authority maximum for AMD may be derived as follows:

$${Tq}_{AMDMax} = f ( {Pwr}_{AMDMax} , {Spd}_{mtr} ) ,$$

where Pwr_{AMDMax} is adjusted upper threshold of AMD power authority and Spdₘₜᵣ is the speed of the motor (e.g., front left, front right, etc.).
A torque authority minimum for AMD may be derived similarly:

$${Tq}_{AMDMin} = f ( {Pwr}_{AMDMin} , {Spd}_{mtr} ) ,$$

where Pwr_{AMDMin} is adjusted lower threshold of AMD power authority and Spdₘₜᵣ is the speed of the motor (e.g., front left, front right, etc.).

At 316, the method 300 includes obtaining an AMD torque request using torque authority for the front left motor, the front right motor, the rear left motor, and the rear right motor. For example, the raw AMD torque request may clipped or constrained by a torque authority range that is the torque authority AMD maximum and torque authority AMD minimum. In one example, the AMD torque request may be obtained as follows:

$${Tq}_{AMDReq} = clip ( {Tq}_{AMDMin} , {Tq}_{{AMDReq}_{Raw}} , {Tq}_{AMDMax} ) ,$$

where Tq_{AMDMin} is the adjusted lower threshold of AMD torque authority and Tq_{AMDMax} is the adjusted upper threshold of AMD torque authority (e.g., front left, front right, etc.).

FIG. 4A, FIG. 4B, and FIG. 4C together illustrate in detail example methods for centralized AMD power authority control. In one example, the methods illustrated with respect to FIGS. 4A-4C may be sub-methods of the method 300 illustrated with FIG. 3. FIG. 4A is a method 400, including a first control concept where a total AMD power authority from all motors of the system can meet a total raw AMD power request from all motors. FIG. 4B is a method 450, including second, third and fourth control concepts for dynamic adjustment of AMD power authority when one or more motors are requesting more AMD power than allocated by AMD power authority. FIG. 4C is a method 470 detailing the fourth control concept including proportional distribution of an available amount of AMD power authority to one or more motors that are in shortage and one or more motors has a surplus. In one example, the method 450 and the method 470 may be sub-methods of the method 400. In one example, the method 400, 450, and 470 may be performed by the centralized AMD power authority control system 50 in electronic communication with the electric machines 135, 123, 120, and 126, the electric energy storage device 132, and the controller 12.

At 402, the method 400 includes receiving a raw upper threshold of AMD power authority, a raw lower threshold of AMD power authority, and a raw AMD power request for each motor of the electric vehicle system (e.g., the front left motor, the front right motor, the rear left motor, and the rear right motor). In other words, the centralized AMD power authority control system receives initial constraints (e.g., before reallocation control) for how much positive or negative power may be used for speed damping and a desired amount of speed damping. In one example, the centralized AMD power authority control system 50 receives a first raw upper threshold and a first raw lower threshold of authorized power for speed damping and a first raw power request of the first motor, and a second raw upper threshold and a second raw lower threshold of authorized power for speed damping and a second raw power request of the second motor, and so on, such as described with respect the method 300. In one example, the upper and lower thresholds, or the raw maximum AMD power authority and the raw minimum AMD power authority, may be determined similarly as described with respect to FIGS. 2A-2B. For example, the raw maximum AMD power authority may be the larger value of the available allocated power after fulfilling a torque demand and a calibratable AMD power authority. In one example, the raw AMD power request may be derived from the raw AMD torque request as described with respect to FIG. 3.

At 404, the method 400 includes calculating a total raw power request for speed damping by the motors of the vehicle, a total upper threshold of AMD power authority, and a total lower threshold of AMD power authority. In one example, the total raw power request for speed damping may be calculated as follows:

$${Pwr}_{{Sum}_{{AmdReq}_{Raw}}} = sum ( {Pwr}_{{AMDReq}_{Raw}} ) @ FL / FR / RL / RR ,$$

where Pwr_{AMDReq}_{_{Raw}} is the raw AMD power request from each of the front left, front right, rear left, and rear right motors. For example, the total raw AMD power request may be the sum of first raw power request from the first motor, the second raw power request from the second motor, and so on.

In one example, the total upper threshold may be a total maximum AMD power authority and calculated as follows:

$${Pwr}_{{Sum}_{LimMax}} = ( {Pwr}_{{AMDMax}_{Raw}} ) @ FL / FR / RL / RR ,$$

where Pwr_{Sum}_{_{LimMax}} is the raw maximum AMD power authority from each of the front left, front right, rear left, and rear right motors. The total maximum AMD power authority may be the sum of the raw maximum AMD power authority from each of the front left, front right, rear left, and rear right motors. For example, the total maximum AMD power authority may be the sum of the first raw upper threshold, the second raw upper threshold, and so on.

In one example, the total lower threshold may be the total minimum AMD power authority and calculated as follows:

$${Pwr}_{{Sum}_{LimMin}} = ( {Pwr}_{{AMDMin}_{Raw}} ) @ FL / FR / RL / RR ,$$

where Pwrₛᵤₘ_{_{LimMin}} is the raw minimum AMD power authority from each of the front left, front right, rear left, and rear right motors. The total minimum AMD power authority may be the sum of the raw minimum AMD power authority from each of the front left, front right, rear left, and rear right motors. For example, the total minimum AMD power authority may be the sum of the first raw lower threshold, the second raw lower threshold, and so on.

At 406, the method 400 includes comparing the total raw AMD power request and the total upper threshold and total lower threshold AMD power authorities to determine if the raw request can be met by the allocated thresholds. In other words, the method 400 determines whether the total requested AMD power falls within a range between the total raw upper threshold of AMD power authority and the total raw lower threshold of AMD power authority. In one example:

$${Pwr}_{{Sum}_{{AMDReq}_{Raw}}} \leq {Pwr}_{{Sum}_{LimMax}} \&\& {Pwr}_{{Sum}_{{AmdReq}_{Raw}}} \geq {Pwr}_{{Sum}_{LimMin}} ,$$

where Pwr_{Sum}_{_{LimMax}} is the total maximum AMD power authority, Pwr_{Sum}_{_{LimMin}} is the total minimum AMD power authority, and

$${Pwr}_{{Sum}_{{AmdReq}_{Raw}}}$$

is the total AMD power request. If the comparison indicates that the total raw AMD power request is less than or equal to the total maximum AMD power authority and the total AMD power request is greater than or equal to the total minimum AMD power authority, the method 400 may continue to 408. In one example, both conditions must be met, e.g., a “logical and”. If the comparison does not indicate that the total raw AMD power request is less than or equal to the total maximum AMD power authority and the total AMD power request is greater than or equal to the total minimum AMD power authority, the method may continue to 410.

At 408, the method 400 determines that the total AMD power request can be met by the total raw maximum AMD power authority and the total raw minimum AMD power authority. In this first condition, the raw AMD power requests of the motors may be fulfilled without clipping and a first control concept may be implemented.

At 412, the first control concept includes setting adjusted thresholds of AMD power authority for each of the front left motor, the front right motor, the rear left motor, and the rear right motor. At 412a, the method 400 includes setting an adjusted upper threshold of AMD power authority to the greater value of the raw AMD power request and zero. At 412b, the method 400 includes setting an adjusted lower threshold of AMD power authority to the smaller value of the raw AMD power request and zero. In one example, the upper threshold of AMD power authority may be set as follows:

$${Pwr}_{AMDMax} = max ( 0 , Pw {r}_{AmdRe {q}_{Raw}} ) ,$$

where Pwr_{AmdReq}_{_{Raw}} is the raw AMD power request for the motor. The adjusted maximum AMD power authority may be set to the greater value of the raw AMD power request and zero. The zero is used here in the case that Pwr_{AmdReq}_{_{Raw}} is negative. For example, a first adjusted upper threshold of AMD power authority may be set to the first raw power request of the first motor. The second adjusted upper threshold of AMD power authority may be set to the second raw power request of the second motor, and so on.
The lower threshold of AMD power authority may be calculated similarly:

$${Pwr}_{AMDMin} = min ( 0 , {Pwr}_{{AmdReq}_{Raw}} ) ,$$

where Pwr_{AmdReq}_{_{Raw}} is the raw AMD power request for the motor. The adjusted minimum AMD power authority may be set to the smaller value of the raw AMD power request and zero. The zero is used here in the case that Pwr_{AmdReq}_{_{Raw}} is positive. For example, a first adjusted lower threshold of AMD power authority may be set to the first raw power request of the first motor. The second adjusted lower threshold of AMD power authority may be set to the second raw power request of the second motor, and so on. The maximum and minimum operations ensure the thresholds have the correct sign. In one example, the method assumes a positive sign for battery discharging power and a negative sign for battery charging power.

At 410, the method 400 determines that the total AMD power request cannot be met. In this case, the method 400 includes directing to FIG. 4B where second, third, and fourth control concepts may be applied based on different conditions for controlling AMD power authority.

Turning now to FIG. 4B, the method 450 addresses various conditions where power authority may be dynamically adjusted for reallocation to motors having insufficient power authority to meet an instantaneous AMD request. For example, when dynamic adjustment of AMD power authority is desired, for a motor having more allocated power authority than raw power request, an adjusted upper threshold and lower threshold of AMD power authority may be set to the raw AMD power request and the surplus power authority reallocated to one or more motors requesting more AMD power than allocated. If no motors are found to have surplus power, each motor's raw AMD power authority may be maintained. In one example, a self-sufficient motor has sufficient power authority to fulfil a power request for speed damping of said motor. In one example, a not self-sufficient motor is a motor requesting more power for speed damping than power authority for speed damping granted to said motor.

At 452, the method 450 includes comparing the total raw AMD power request to the total upper threshold of AMD power authority. In other words, the method 450 determines whether the total raw AMD power request is greater than or equal to the total maximum AMD power authority. In one example:

$${Pwr}_{{Sum}_{{AMDReq}_{Raw}}} > {Pwr}_{{Sum}_{LimMax}} ,$$

where Pwrₛᵤₘ_{_{LimMax}} is the total maximum AMD power authority and

$${Pwr}_{{Sum}_{{AMDReq}_{Raw}}}$$

is the total raw AMD power request. The decision block 452 differentiates between actions for requesting and reallocating available discharge power (yes at 452) and actions for requesting and reallocating available charge power (no at 452). The method 450 and the method 470 detail example actions for reallocating discharge power. However, it may be understood that the method 450 and the method 470 may be applied similarly for reallocating charge power.

Responsive to the total raw AMD power request is not exceeding the total upper threshold of AMD power authority, at 467 the method includes requesting dynamic adjustment of charge power. At 468, the method 450 includes performing the similar action as a discharge of power, which is described in the following steps.

Responsive to the total raw AMD power request exceeding the total upper threshold of AMD power authority, at 453 the method includes requesting dynamic adjustment of discharge power.

At 454, the method 450 includes checking for each of the front left motor, the front right motor, the rear left motor, and the rear right motor whether the motor is self-sufficient and recording the number of motors that are self-sufficient. In one example, the method 450 at 454a sets the number of self-sufficient motors to zero:

$${N}_{mtrSelfSuff} = 0 ,$$

At 454b the method 450 evaluates whether the motor has surplus AMD power authority. In one example, the method 450 includes calculating for each motor a difference between the raw upper threshold of AMD power authority and the AMD power request:

$${Pwr}_{DiffLimvsReq} = {Pwr}_{{AMDMax}_{raw}} - {Pwr}_{{AMDReq}_{raw}} ,$$

where Pwr_{AMDMax}_{_{raw}} is the raw maximum AMD power authority and Pwr_{AMDReq}_{_{raw}} is the raw AMD power request, and Pwr_{DiffLimvsReq} is the difference between the raw AMD power request and the raw upper threshold of AMD power authority.

At 456, if for an evaluated motor the difference between the raw upper threshold of AMD power authority and the AMD power request is greater than or equal to zero, self-sufficiency is indicated for the motor:

$${Pwr}_{DiffLimvsReq} \geq 0.$$

In one example, the number of motors that are self-sufficient may be 0, 1, 2, or 3 but not 4, as 4 self-sufficient motors would belong to the first condition described with respect to FIG. 4A where the total AMD power request can be met and there is no need to clip any AMD raw power request. A motor reference index may be assigned to each motor such as using a number to represent a motor. For example, a reference index may include: front left (FL), front right (FR), rear left (RL), rear right (RR): [1234].

If the motor is self-sufficient, the method 450 continues to the second control concept at 458. In one example, the second control concept may be applicable to a second condition where at least one motor is self-sufficient and one or more motors are not self-sufficient. The second control concept may be applied to the self-sufficient motor. At 458a, for the self-sufficient motor, the second control concept includes setting the adjusted upper threshold of AMD power authority to the AMD power request. In one example:

$$set {Pwr}_{AMDMax} = max ( 0 , {Pwr}_{{AMDReq}_{Raw}} ) ,$$

where Pwr_{AmdReq}_{_{Raw}} is the raw AMD power request for the motor. The adjusted upper threshold of AMD power authority may be set to the greater value of the raw AMD power request and zero.

At 458b, the second control concept includes increasing the self-sufficient motor count by 1. In one example:

$$count {N}_{mtrSelfSuff} = {N}_{mtrSelfSuff} + 1 ,$$

where N_{mtrSelfSuff}, the count may be increased by one.

At 458c, the second control concept includes storing the motor's reference index into a set. In one example:

$$S e {t}_{SelfSuff} = union ( {mtr}_{index} ) ,$$

where Set_{SelfSuff} is the index of self-sufficient motors and mtr_{index} is the reference index of the evaluated motor, the motor's index may be added to the set.

From 458, the method returns to 454b to check whether a second motor, a third motor, and so on is self-sufficient.

Returning to 456, if the motor is not self-sufficient, the method 450 includes taking no action at 460. For example, the self-sufficient count is not increased and the motor's reference index is not stored into the self-sufficient set. From 460, the method returns to 456 to check whether a second motor, a third motor, and so on is self-sufficient.

All motors having been checked, the method 450 includes determining whether no motor is self-sufficient at 462:

$${N}_{mtrSelfSuff} == 0 ,$$

where N_{mtrSelfSuff} is the count of self-sufficient motors. The method evaluates whether the count is equal to zero. In other words, the method determines whether no motors have surplus AMD power authority available for reallocating to another motor. If no motor is self-sufficient, the method 450 continues to the third control concept at 464. In this case, there is no available AMD power author for reallocation. If at least one motor is self-sufficient, the method 450 continues to the fourth control concept at 466. In this case, one or more motors have AMD power authority to share with the other motors.

At 464, the third control concept includes for each of the front left, front right, rear left, and rear right motors setting the adjusted upper threshold of AMD power authority to the raw upper threshold of AMD power authority. In other words, the method includes maintaining the maximum AMD power authority at the maximum raw AMD power authority. In one example, for each motor set:

$${Pwr}_{AMDMax} = {Pwr}_{AMDMaxRaw} ,$$

where Pwr_{AMDMax}_{_{Raw}} is the raw maximum AMD power authority and Pwr_{AMDMax} is the adjusted maximum power authority. In one example, the third control concept may be applicable to a third condition where none of the motors is self-sufficient. In one example, the method may include evenly distributing the power authority shortage across the motors.

At 466, the fourth control concept includes proportionally distributing total power authority available to the motors that are in shortage of AMD power authority. In one example, the fourth control concept may be applicable to the second condition where at least one motor is self-sufficient and one or more motors are not self-sufficient. The fourth control concept may be applied to the not self-sufficient motor or motors. The fourth concept is detailed in FIG. 4C.

FIG. 4C illustrates a method 470 reallocating power authority among motors in an electric vehicle. In one example, the method 470 provides a detailed example of the fourth control concept for AMD power authority control including, while one or more motors are self-sufficient, proportionally distributing available AMD authority among the motors having less power authority than requested for AMD. The method 470 is one example of a method of maximum power authority control. The method 470 may be applied similarly for minimum power authority control.

At 472, the method 470 includes calculating the total power authority available that can be reallocated from self-sufficient motors. In one example, the calculation includes:

$${Pwr}_{totReAlloc} = {sum ( {Pwr}_{DiffLimsvsReq} )}_{i} ,$$

where i=1: N_{mtrSelfSuff}, e.g., for motors belonging to Set_{SelfSuff} and Pwr_{DiffLimsvsReq} is the difference between the raw maximum AMD power authority and the raw AMD power request for each motor in the set. The total power authority available for reallocation, Pwr_{totReAlloc}, is the sum of the differences of the motors of the set.

At 474, the method 470 includes determining how many motors are not self-sufficient. In one example, the calculation includes:

$$M = 4 - {N}_{mtrSelfSuff} ,$$

where 4 refers to the total number of motors (e.g., 4-motor, 3-motor, and so on). The number of not self-sufficient motors is difference between the total number of motors and number of motors belonging to the set of self-sufficient motors.

At 476, the method 470 includes retrieving the motor reference set for the one or more motors that are not self-sufficient. In one example:

$${Set}_{NotSetSuff} = Complement ( {Set}_{SelfSuff} ) .$$

The method 450 derives the set of not self-sufficient motors as the complement of the indexed set of self-sufficient motors. For example, if Set_SelfSuff=[1,3], then Set_NotSelfSuff=[2,4].

At 478, the method 470 includes proportionally distributing the available power authority to the motors in the not-self-sufficient set, where the number of motors in the not-self-sufficient set is 1, 2 or 3. It may not be 4, as 4 not-self-sufficient motors would belong to the third condition described with respect to FIG. 4B where there is no available power authority for reallocation.

The method 470 includes at 478a, calculating a total power shortage among the set of not self-sufficient motors. In one example:

$$P w {r}_{totShortage} = sum ( {abs ( {Pwr}_{DiffLimvsReq} )}_{j} ) ,$$

where j is a motor belonging to Set_{NotSetSuff} and Pwr_{DiffLimvsReq} is the difference between the raw AMD power authority and the raw AMD power request. The total power shortage, Pwr_{totShortage}, may be the sum of the absolute value of the each motor's amount of power authority shortage.

At 478b, the method 470 includes determining a reallocation ratio for each motor belonging to the set of not-self-sufficient motors. In one example, the reallocation ratio may be based on a power ratio calculated as follows:

$$R {t}_{j} = \frac{{abs ( {Pwr}_{DiffLimvsReq} )}_{j}}{{Pwr}_{totShortage}} ;$$

where Pwr_{DiffLimvsReq} is the amount of shortage for motor j and Pwr_{totShortage} is the total shortage of the not self-sufficient motors. The reallocation ratio may be the absolute value of the power shortage of an individual motor (e.g., each motor j) as a proportion of the total power shortage.

At 478c, the method 470 includes reallocating power authority granted to AMD for each motor of the set of not-self-sufficient motors. In one example:

$$P w {r}_{{AMDMax}_{j}} = P w {r}_{{AMDMax}_{R a {w}_{j}}} + R {t}_{j} * P w {r}_{totReAlloc} ,$$

where Pwr_{AMDMax}_{_{Rawj}} is the raw maximum AMD power authority, Rtⱼ is the reallocation ratio of the motor j, and Pwr_{totReAlloc} is the total power available for reallocation. The adjusted upper threshold of each not self-sufficient motor may be the sum of the motor's raw maximum AMD power authority and an additional amount that is a ratio of the total available maximum power authority for reallocation.

An adjusted raw minimum AMD power authority may be obtained similarly for motors in shortage of charge power. In one example, the adjusted raw maximum AMD power authority and the adjusted raw minimum AMD power authority for each motor may be used to derive torque authority thresholds on the AMD torque request of each motor of the BEV, such as described with respect to FIG. 3. The AMD torque request may then be applied to each motor as an amount of feedback control for damping motor speed oscillations.

Turning now to FIG. 5, a timing diagram 500 is shown that illustrates a sequence of actions performed within a control method for centralized AMD power authority control for an exemplary 3-motor BEV. The control method may be the same as or similar to the series of actions described above in reference to the method 300, the method 400, the method 450, and the method 470 in FIGS. 3, 4A, 4B, and 4C, respectively. Particularly, timing diagram 500 illustrates exemplary scenarios of positive (e.g., discharge) AMD power authority control. The 3-motor BEV may be an example similar to the vehicle propulsion system 100 shown in FIG. 1. Instructions for performing the centralized AMD power authority control described in the timing diagram 500 of FIG. 5 may be executed by a controller (e.g., the controller 12 of control system 14 of FIG. 1) based on instructions stored on a memory of the controller and in conjunction with sensory feedback received from components from the vehicle propulsion system, including sensors 16, electric machine 135, electric machine 120, electric machine 123, and electric energy storage device 132 described above with reference to FIG. 1. The horizontal (x-axis) denotes time and the vertical markers t0-t3 identify relevant times in methods 300, 400, 450, and 470 of FIGS. 3, 4A-C, respectively, for centralized AMD power authority control in a 3-motor BEV. For the duration of t0 to t3, the vehicle is controlled in motor torque control mode such that the speed damping control is enabled. With speed damping control enabled, the amount of AMD torque correction is continuously calculated with the value changing dynamically, and therefore AMD power authority control is changing dynamically.

Timing diagram 500 shows plots 502, 504, 506, 508, 510, 512, 514, 516, 518, which illustrate control settings of the vehicle system over time. Plots 502, 504, and 506 indicate first motor AMD control settings including raw maximum AMD power authority at 502, raw AMD power request at 504, and adjusted AMD maximum power authority at 506. Plots 508, 510, and 512 indicate second motor AMD control settings including raw maximum AMD power authority at 508, raw AMD power request at 510, and adjusted AMD maximum power authority at 512. Plots 514, 516, and 518 indicate third motor AMD control settings including raw maximum AMD power authority at 514, raw AMD power request at 516, and adjusted AMD maximum power authority at 518. Plots 502, 504, 506, 508, 510, 512, 514, 516, 518 show a positive increase upwards along the y-axis. Plots 502, 504, 506, 508, 510, 512, 514, 516, 518 illustrate the control settings of the vehicle system across three durations: a first duration from time t0 to time t1; a second duration from time t1 to time t2; and a third duration from time t2 to time t3.

From time t0 to time t1, the centralized AMD power authority control system receives the raw maximum AMD power authority from the first motor at 502, the second motor at 508, and the third motor at 514 and the raw AMD power request from the first motor at 504, the second motor at 510, and the third motor at 516. For the duration from time t0 to t1, the centralized power authority control system determines the total raw AMD power request does not exceed the total raw maximum AMD power authority. For example, at any point along t0 to t1, a sum of the raw AMD power request from the first motor at 504, the second motor at 510, and the third motor at 516 does not exceed the sum of the raw maximum AMD power authority granted to the first motor at 502, the second motor at 508, and the third motor at 514. In response to finding that the total raw AMD power request does not exceed the total raw maximum AMD power authority, from t0 to t1, the centralized AMD power authority control system controls the first motor, the second motor, and the third motor using the first control concept, such as described with respect to FIG. 4A. For example, at any point along t0 to t1, the adjusted maximum AMD power authority of the first motor at 506 is set to the raw AMD power request indicated at 504. Similarly, from t0 to t1, the adjusted maximum AMD power authority of the second motor at 512 is set to the raw AMD power request indicated at 510, and the adjusted maximum AMD power authority of the third motor at 518 is set to the raw AMD power request indicated at 516. Note that in the plots, the adjusted maximum AMD power authority is shown slightly below the raw AMD power request so as to be visible; however, it may be understood that the adjusted maximum AMD power authority provided to the control system to control driveline oscillation, e.g., as described with respect to FIG. 3, is set to (e.g., is set to equal) the raw AMD power request.

From time t1 to time t2, the centralized AMD power authority control system continues to receive the raw maximum AMD power authority from the first motor at 502, the second motor at 508, and the third motor at 514 and the raw AMD power request from the first motor at 504, the second motor at 510, and the third motor at 516. For the duration from time t1 to t2, the centralized AMD power authority control system determines the total raw AMD power request exceeds the total raw AMD power authority. For example, for the duration from t1 to t2, the sum of the raw AMD power request from the first motor at 504, the second motor at 510, and the third motor at 516 exceeds the sum of the raw maximum AMD power authority granted to the first motor at 502, the second motor at 508, and the third motor at 514. In addition, for the duration from time t1 to t2, at no point is the AMD power request of the first motor, the second motor, or the third motor less than the raw maximum AMD power authority granted to the respective motor. In other words, at no point from time t1 to t2 is any of the three motors self-sufficient. In response to finding that the total raw AMD power request exceeds the total raw maximum AMD power authority and no motor is self-sufficient, from t1 to t2 the centralized AMD power authority control system controls the first motor, the second motor, and the third motor using the third control concept, such as described with respect to FIG. 4B. For example, at any point from t1 to t2, the adjusted maximum AMD power authority for the first motor at 506 is set to the raw maximum AMD power authority indicated at 502. Similarly, from t1 to t2, the adjusted AMD power authority for the second motor at 512 is set to the raw maximum AMD power authority indicated at 508, and the adjusted AMD power authority for the third motor at 518 is set to the raw maximum AMD power authority indicated at 514. As above, in the plots, the adjusted maximum AMD power authority is shown slightly below the raw maximum AMD power authority so as to be visible; however, it may be understood that the adjusted maximum AMD power authority provided to the control system to control driveline oscillation, e.g., as described with respect to FIG. 3, is set to (e.g., is set to equal) the raw maximum AMD power authority.

From time t2 to time t3, the centralized AMD power authority control system continues to receive the raw maximum AMD power authority from the first motor at 502, the second motor at 508, and the third motor at 514 and the raw AMD power request from the first motor at 504, the second motor at 510, and the third motor at 516. For the duration from time t2 to t3, the centralized AMD power authority control system determines the total raw AMD power request exceeds the total raw AMD power authority. For example, for the duration from t2 to t3, the sum of the raw AMD power request from the first motor at 504, the second motor at 510, and the third motor at 516 exceeds the sum of the raw maximum AMD power authority granted to the first motor at 502, the second motor at 508, and the third motor at 514. In contrast with the duration from t1 to t2, for the duration from time t2 to t3, the raw AMD power request of the first motor at 504 remains below the raw maximum AMD power authority granted to the first motor at 502. In other words, from time t2 to t3, the first motor is self-sufficient. In response to finding that the total raw AMD power request exceeds the total raw maximum AMD power authority and the first motor is self-sufficient, from t2 to t3 the centralized AMD power authority control system controls the first motor using the second control concept, such as described with respect to FIG. 4B. The centralized AMD power authority control system controls the second motor and the third motor using the fourth control concept, such as described with respect to FIGS. 4B-4C.

Following the second control concept, the adjusted maximum AMD power authority for the first motor at 506 is set to the raw AMD power request indicated at 504. Following the fourth control concept, to determine the adjusted maximum AMD power authority for the second motor at 512 and the third motor at 518, the centralized AMD power authority control system calculates the total maximum AMD power authority available that can be re-allocated from the first motor and proportionally distributes the available maximum AMD power authority to the second motor and the third motor. For example, the available maximum AMD power authority at any point between t2 and t3 is the difference between the raw AMD power request and the raw maximum AMD power authority of the first motor at 504 and 502, respectively. The available AMD power authority is proportionally distributed to the second motor and third motor based on a power ratio that is the absolute difference between the raw maximum AMD power authority and raw AMD power request of each motor as a proportion of the total power authority shortage. In other words, the power ratio is the motor's individual power authority shortage as a proportion of the total power authority shortage. For example, from t2 to t3, the total power authority shortage is the difference between the sum of the raw AMD power request of the second motor and third motor at 510 and 516, respectively, and the sum of the raw maximum AMD power authority of the second motor and the third motor at 508 and 514, respectively. Therefore, the adjusted AMD power authority for the second motor at 512 is the sum of the raw maximum AMD power authority at 508 and the proportion of available power authority corresponding to the second motor's power ratio. Similarly, the adjusted AMD power authority for the second motor at 518 is the sum of the raw maximum AMD power authority at 514 and the proportion of available power authority corresponding to the third motor's power ratio.

The systems and methods described herein enable centralized AMD power authority control for 2-motor, 3-motor, and 4-motor BEV systems. By integrating powertrain controls for all motors in the same control system, the AMD power authority granted to all motors and the motors AMD power requests are considered as a whole. In this way, dynamic reallocation of power authority among the motors is enabled. In doing so, battery power may be used more efficiently and incidences of degraded performance of speed damping may be reduced.

In one example, the centralized AMD power authority control system may implement a variety of control strategies based on operating conditions. For example, a first control strategy may be implemented when total AMD power authority granted to the motors is sufficient to meet the total raw AMD requests of the motors. The first control strategy may include using the raw power request of each motor as the upper threshold and the lower threshold of AMD power authority. For example, a second control strategy may be implemented when dynamic adjustment of AMD power authority is desired across the motors. For the particular motor that has more AMD power authority than AMD power request, the second control strategy may include setting the upper threshold of AMD power authority to the power request of the motor. A lower threshold of AMD power authority may be set similarly. If no motor has more AMD power authority than AMD power request, a third control strategy may include maintaining the raw upper threshold and raw lower threshold of AMD power authorities. A fourth control strategy may be implemented when dynamic adjustment of AMD power authority is desired across the motors and a least one motor has more AMD power authority than AMD power request. In this scenario, the available power may be a proportionally distributed among the motors that are in shortage of power authority. The centralized AMD power authority control systems and methods of described herein have the technical effect of enabling operation of 2-motor, 3-motor, and 4-motor configuration BEVs thereby providing drivers more choice in the electric vehicle market.

In another representation, a method to control power authority for damping for a battery electric vehicle with at least two motors using a centralized integrated control system, the method comprising: receiving from each of the at least two motors a raw upper threshold of active motor damping (AMD) power authority, a raw lower threshold of AMD power authority, and an AMD power request; summing a total requested AMD power, a total raw upper threshold of AMD power authority, and a total raw lower threshold of AMD power authority, comparing the total requested AMD power with the total raw upper threshold of AMD power authority and the total raw lower threshold of AMD power authority; and in response to the total requested AMD power falling within the total raw upper threshold of AMD power authority and the total raw lower threshold of AMD power authority, setting an adjusted upper threshold of AMD power authority and an adjusted lower threshold of AMD power authority to the AMD power request of each motor; and in response to the total requested AMD power falling outside of the total raw upper threshold of AMD power authority and the total raw lower threshold of AMD power authority, if at least one motor has more AMD power authority than requested, setting the adjusted upper threshold of AMD power authority and the adjusted lower threshold of AMD power authority to the AMD power request for each motor having more AMD power authority than requested AMD power and reallocating available total AMD power authority to one or more motors that are in shortage of AMD power authority; and in response to the total requested AMD power falling outside of the total raw upper threshold of AMD power authority and the total raw lower threshold of AMD power authority, if no motor has more AMD power authority than AMD power request, setting the adjusted upper threshold of AMD power authority to the raw upper threshold of AMD power authority and the adjusted lower threshold of AMD power authority to the raw lower threshold of AMD power authority for each motor.

The disclosure also provides support for a method for an electric vehicle having at least two motors providing drive torque, the method comprising: operating with speed damping control, including determining that a first motor has more power authority than requested and a second motor has a shortage of power authority, and in response, reallocating power authority from the first motor to the second motor to increase usage of authorized power for speed damping. In a first example of the method, the first motor and the second motor are in electronic communication with a centralized integrated control system. In a second example of the method, optionally including the first example, operating with speed damping control further comprises receiving a first raw upper threshold and a first raw lower threshold of authorized power for speed damping and a first raw power request from the first motor and a second raw upper threshold and a second raw lower threshold of authorized power for speed damping and a second raw power request from the second motor, and adjusting power thresholds of the first motor and the second motor based on a comparison between a total raw upper threshold calculated from the first raw upper threshold and the second raw upper threshold, a total raw lower threshold calculated from the first raw lower threshold and the second raw lower threshold, and a total raw power request calculated from the first raw power request and the second raw power request. In a third example of the method, optionally including one or both of the first and second examples, in response to the total raw power request being less than or equal to the total raw upper threshold and more than or equal to the total raw lower threshold, setting a first adjusted upper threshold and a first adjusted lower threshold of authorized power to the first raw power request of the first motor, and setting a second adjusted upper threshold and a second adjusted lower threshold of authorized power the second raw power request of the second motor. In a fourth example of the method, optionally including one or more or each of the first through third examples, in response to the total raw power request being more than the total raw upper threshold or the total raw power request being less than the total raw lower threshold, and the first motor having more power authority than requested, setting an adjusted upper threshold and an adjusted lower threshold of authorized power to the first raw power request of the first motor and setting the adjusted upper threshold and the adjusted lower threshold of authorized power for the second motor based on an available power authority for speed damping. In a fifth example of the method, optionally including one or more or each of the first through fourth examples, in response to the total raw power request being more than the total raw upper threshold or the total raw power request being less than the total raw lower threshold, and no motor having more power authority than power request, setting a first adjusted upper threshold to the first raw upper threshold of authorized power and a first adjusted lower threshold to the first raw lower threshold of authorized power for the first motor, and setting a second adjusted upper threshold to the second raw upper threshold of authorized power and a second adjusted lower threshold to the second raw lower threshold of authorized power for the second motor. In a sixth example of the method, optionally including one or more or each of the first through fifth examples, the method further comprises: operating with speed damping control responsive to an indication that the electric vehicle is operating in a motor torque control mode, and maintaining power allocation without reallocation for speed damping control responsive to an indication that the electric vehicle is not operating with speed damping control. In a seventh example of the method, optionally including one or more or each of the first through sixth examples, the method further comprises: constraining a torque request for speed damping based on an adjusted upper threshold of authorized power and an adjusted lower threshold of authorized power and motor speed of each of the at least two motors and providing the torque request to actuators of the at least two motors to reduce driveline oscillation.

The disclosure also provides support for a method to control power authority for speed damping for a battery electric vehicle with at least two motors using a centralized integrated control system, the method comprising: setting an adjusted upper threshold and an adjusted lower threshold for active motor damping (AMD) power authority based on a raw AMD power request from each of the at least two motors in response to a total AMD power authority exceeding a total raw AMD power request from all motors, in response to a request for a dynamic adjustment of AMD power authority for a motor of the at least two motors, setting the adjusted upper threshold and the adjusted lower threshold for AMD power authority to the raw AMD power request of the motor if AMD power authority exceeds the raw AMD power request of the motor, and reallocating available total AMD power authority to one or more motors of the at least two motors that are in shortage of AMD power authority. In a first example of the method, the reallocating includes calculating the available total AMD power authority that can be reallocated from one or more motors with sufficient power authority to the one or more motors in shortage of AMD power authority. In a second example of the method, optionally including the first example, the reallocating includes determining how many of the one or more motors are in shortage of AMD power authority. In a third example of the method, optionally including one or both of the first and second examples, the reallocating includes retrieving a reference set for the one or more motors in shortage of AMD power authority. In a fourth example of the method, optionally including one or more or each of the first through third examples, the reallocating includes proportionally distributing the available total AMD power authority to each of the one or more motors that are in shortage of AMD power authority. In a fifth example of the method, optionally including one or more or each of the first through fourth examples, the available total AMD power authority is proportionally distributed between no more than three motors. In a sixth example of the method, optionally including one or more or each of the first through fifth examples, the method further comprises: setting the adjusted upper threshold and the adjusted lower threshold for AMD power authority based on a raw upper threshold and a raw lower threshold for AMD power authority from each of the at least two motors in response to the total raw AMD power request exceeding the total AMD power authority allocated to the at least two motors and no motors having a surplus of AMD power authority.

The disclosure also provides support for a system for a vehicle, comprising: an electric vehicle battery, a first motor coupled to a first axle of the vehicle, a second motor coupled to the first axle of the vehicle, a third motor coupled to a second axle of the vehicle, a fourth motor coupled to the second axle of the vehicle, a centralized integrated control system in communication with the electric vehicle battery, the first motor, the second motor, the third motor, and the fourth motor, and a controller including executable instructions stored in non-transitory memory that cause the centralized integrated control system to set an upper threshold and lower threshold for active motor damping (AMD) power authority based on a raw AMD power request of each motor in response to a total AMD power authority exceeding a total raw AMD power request from all motors, in response to a request for a dynamic adjustment of AMD power authority for a motor, set an adjusted upper threshold and adjusted lower threshold for AMD power authority to the raw AMD power request of the motor if AMD power authority exceeds the raw AMD power request of the motor, and reallocate available total AMD power authority to one or more motors that are in shortage of AMD power authority. In a first example of the system, the available total AMD power authority is reallocated to one or more motors in shortage of AMD power authority proportionally based on a power ratio, where the power ratio is calculated as an absolute value of a power authority shortage of a first motor of the one or more motors that are in shortage as a proportion of a total power authority shortage calculated from the one or more motors that are in shortage. In a second example of the system, optionally including the first example, the available total AMD power authority is proportionally distributed between no more than three motors. In a third example of the system, optionally including one or both of the first and second examples, the system further comprises: executable instructions that cause the centralized integrated control system to set the adjusted upper threshold to a raw upper threshold of AMD power authority and the adjusted lower threshold to a raw lower threshold of AMD power authority of each motor in response no motor having more AMD power authority than raw AMD power request. In a fourth example of the system, optionally including one or more or each of the first through third examples, the system further comprises: executable instructions that cause the controller to command an AMD torque request for each motor constrained by the adjusted upper threshold and the adjusted lower threshold for AMD power authority and motor speed.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a thresholding sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for an electric vehicle having at least two motors providing drive torque, the method comprising:
operating with speed damping control, including determining that a first motor has more power authority than requested and a second motor has a shortage of power authority, and in response, reallocating power authority from the first motor to the second motor to increase usage of authorized power for speed damping.

2. The method of claim 1, wherein the first motor and the second motor are in electronic communication with a centralized integrated control system.

3. The method of claim 1, wherein operating with speed damping control further comprises receiving a first raw upper threshold and a first raw lower threshold of authorized power for speed damping and a first raw power request from the first motor and a second raw upper threshold and a second raw lower threshold of authorized power for speed damping and a second raw power request from the second motor, and adjusting power thresholds of the first motor and the second motor based on a comparison between a total raw upper threshold calculated from the first raw upper threshold and the second raw upper threshold, a total raw lower threshold calculated from the first raw lower threshold and the second raw lower threshold, and a total raw power request calculated from the first raw power request and the second raw power request.

4. The method of claim 3, wherein in response to the total raw power request being less than or equal to the total raw upper threshold and more than or equal to the total raw lower threshold, setting a first adjusted upper threshold and a first adjusted lower threshold of authorized power to the first raw power request of the first motor, and setting a second adjusted upper threshold and a second adjusted lower threshold of authorized power the second raw power request of the second motor.

5. The method of claim 3, wherein in response to the total raw power request being more than the total raw upper threshold or the total raw power request being less than the total raw lower threshold, and the first motor having more power authority than requested, setting an adjusted upper threshold and an adjusted lower threshold of authorized power to the first raw power request of the first motor and setting the adjusted upper threshold and the adjusted lower threshold of authorized power for the second motor based on an available power authority for speed damping.

6. The method of claim 3, wherein in response to the total raw power request being more than the total raw upper threshold or the total raw power request being less than the total raw lower threshold, and no motor having more power authority than power request, setting a first adjusted upper threshold to the first raw upper threshold of authorized power and a first adjusted lower threshold to the first raw lower threshold of authorized power for the first motor, and setting a second adjusted upper threshold to the second raw upper threshold of authorized power and a second adjusted lower threshold to the second raw lower threshold of authorized power for the second motor.

7. The method of claim 1, further comprising operating with speed damping control responsive to an indication that the electric vehicle is operating in a motor torque control mode, and maintaining power allocation without reallocation for speed damping control responsive to an indication that the electric vehicle is not operating with speed damping control.

8. The method of claim 1, further comprising constraining a torque request for speed damping based on an adjusted upper threshold of authorized power and an adjusted lower threshold of authorized power and motor speed of each of the at least two motors and providing the torque request to actuators of the at least two motors to reduce driveline oscillation.

9. A method to control power authority for speed damping for a battery electric vehicle with at least two motors using a centralized integrated control system, the method comprising:
setting an adjusted upper threshold and an adjusted lower threshold for active motor damping (AMD) power authority based on a raw AMD power request from each of the at least two motors in response to a total AMD power authority exceeding a total raw AMD power request from all motors;
in response to a request for a dynamic adjustment of AMD power authority for a motor of the at least two motors, setting the adjusted upper threshold and the adjusted lower threshold for AMD power authority to the raw AMD power request of the motor if AMD power authority exceeds the raw AMD power request of the motor; and
reallocating available total AMD power authority to one or more motors of the at least two motors that are in shortage of AMD power authority.

10. The method of claim 9, wherein the reallocating includes calculating the available total AMD power authority that can be reallocated from one or more motors with sufficient power authority to the one or more motors in shortage of AMD power authority.

11. The method of claim 10, wherein the reallocating includes determining how many of the one or more motors are in shortage of AMD power authority.

12. The method of claim 9, wherein the reallocating includes retrieving a reference set for the one or more motors in shortage of AMD power authority.

13. The method of claim 9, wherein the reallocating includes proportionally distributing the available total AMD power authority to each of the one or more motors that are in shortage of AMD power authority.

14. The method of claim 13, wherein the available total AMD power authority is proportionally distributed between no more than three motors.

15. The method of claim 9, further comprising setting the adjusted upper threshold and the adjusted lower threshold for AMD power authority based on a raw upper threshold and a raw lower threshold for AMD power authority from each of the at least two motors in response to the total raw AMD power request exceeding the total AMD power authority allocated to the at least two motors and no motors having a surplus of AMD power authority.

16. A system for a vehicle, comprising:
an electric vehicle battery;
a first motor coupled to a first axle of the vehicle;
a second motor coupled to the first axle of the vehicle;
a third motor coupled to a second axle of the vehicle;
a fourth motor coupled to the second axle of the vehicle;
a centralized integrated control system in communication with the electric vehicle battery, the first motor, the second motor, the third motor, and the fourth motor; and
a controller including executable instructions stored in non-transitory memory that cause the centralized integrated control system to set an upper threshold and lower threshold for active motor damping (AMD) power authority based on a raw AMD power request of each motor in response to a total AMD power authority exceeding a total raw AMD power request from all motors;
in response to a request for a dynamic adjustment of AMD power authority for a motor, set an adjusted upper threshold and adjusted lower threshold for AMD power authority to the raw AMD power request of the motor if AMD power authority exceeds the raw AMD power request of the motor; and
reallocate available total AMD power authority to one or more motors that are in shortage of AMD power authority.

17. The system of claim 16, wherein the available total AMD power authority is reallocated to one or more motors in shortage of AMD power authority proportionally based on a power ratio, where the power ratio is calculated as an absolute value of a power authority shortage of a first motor of the one or more motors that are in shortage as a proportion of a total power authority shortage calculated from the one or more motors that are in shortage.

18. The system of claim 16, wherein the available total AMD power authority is proportionally distributed between no more than three motors.

19. The system of claim 16, further comprising executable instructions that cause the centralized integrated control system to set the adjusted upper threshold to a raw upper threshold of AMD power authority and the adjusted lower threshold to a raw lower threshold of AMD power authority of each motor in response no motor having more AMD power authority than raw AMD power request.

20. The system of claim 16, further comprising executable instructions that cause the controller to command an AMD torque request for each motor constrained by the adjusted upper threshold and the adjusted lower threshold for AMD power authority and motor speed.
